(19) United States
(12) Patent Application Publication
(10) Pub. No.: US 2009/0135375 A1
(43) Pub. Date: May 28, 2009

(54) Color and brightness compensation in laser projection systems

(76) Inventors: Jacques Gollier, Painted Post, NY (US); James Micheal Harris, Elmira, NY (US)

Correspondence Address: CORNING INCORPORATED, SP-TI-3-1, CORNING, NY, 14831, US

(21) Appl. No.: 11/986,733

(22) Filed: Nov. 26, 2007

(51) Int. Cl. G03B 21/14

(52) U.S. Cl. 353/31

(57) ABSTRACT

A multi-color laser projection system comprising a multi-color laser source, laser projection optics, an optical intensity monitor, and a projection controller is provided. The multi-color laser source is configured to generate a frequency-converted optical beam λ₁, and a native frequency optical beam λ₂. The laser projection optics is configured to generate a scanned laser image utilizing the frequency-converted optical beam λ₁, and a native frequency laser beam λ₂. The laser projection optics is configured to direct a portion of the frequency-converted optical beam λ₁ to the optical intensity monitor. The projection controller is programmed to vary the intensity of the native frequency optical beam λ₂ as a function of the intensity of the frequency-converted optical beam λ₁. Additional embodiments are disclosed and claimed.

### BACKGROUND

The present invention relates to multi-color laser projection systems and, more particularly, to color correction and brightness balance in laser projection systems where at least one of the optical beams generated by the laser source of the projection system is a frequency-converted optical beam. For example, and not by way of limitation, a scanned laser projection system commonly employs red, green, and blue optical beams to generate the scanned laser image. The red and blue optical beams are commonly generated using native wavelength laser sources. In contrast, the green optical beam is often generated by combining a red or infrared native semiconductor laser, such as a distributed feedback (DFB) laser, a distributed Bragg reflector (DBR) laser, a Fabry-Perot laser, a vertical cavity surface emitting (VCSEL) laser, or the like, with a light wavelength conversion device, such as a second harmonic generation (SHG) crystal.

The SHG crystal can be configured to generate higher harmonic waves of the fundamental laser signal by tuning, for example, a 1060 nm DBR or DFB laser to the spectral center of an SHG crystal, which converts the wavelength to 530 nm. However, the wavelength conversion efficiency of an SHG crystal, such as MgO-doped periodically poled lithium niobate (PPLN), is strongly dependent on the wavelength matching between the laser diode and the SHG crystal. The bandwidth of a PPLN SHG device is often very small—for a typical PPLN SHG wavelength conversion device, the full width half maximum (FWHM) wavelength conversion bandwidth is only in the 0.16 to 0.2 nm range and mostly depends on the length of the crystal. Mode hopping or uncontrolled large wavelength variations within the laser cavity can cause the output wavelength of a semiconductor laser to move outside of this allowable bandwidth during operation. Once the semiconductor laser wavelength deviates from the optimum conversion wavelength of the PPLN SHG device, the output power of the conversion device at the target wavelength drops. In laser projection systems, for example, mode hops are particularly problematic because they can generate instantaneous changes in power that will be readily visible as defects at specific locations in the image. These visible defects typically manifest themselves as organized, patterned image defects across the image because the generated image is simply the signature of the temperature evolution of the different sections of the laser.

### BRIEF SUMMARY

Given the challenges associated with wavelength matching and stabilization in developing semiconductor laser sources for laser projection systems, the present inventors have recognized beneficial schemes for color correction and brightness balance in laser projection systems where at least one of the optical beams generated by the laser source of the projection system is a frequency-converted optical beam.

According to one embodiment of the present invention, a multi-color laser projection system comprising a multi-color laser source, laser projection optics, an optical intensity monitor, and a projection controller is provided. The multi-color laser source is configured to generate a frequency-converted optical beam λ₁ and one or more native frequency optical beams λ₂, λ₃, etc. The laser projection optics is configured to generate a scanned laser image utilizing the frequency-converted optical beam λ₁ and a native frequency laser beams λ₂, λ₃, etc. The laser projection optics is configured to direct a portion of the frequency-converted optical beam λ₁ to the optical intensity monitor. The projection controller is programmed to compensate for the intensity errors occurring in the frequency-converted optical beam λ₁ such that

ΔI_{λ}_{₂}=ƒ(ΔI_{λ}_{₁})

where ΔI_{λ}_{₁} represents a variation from a baseline data intensity signal in the frequency converted optical beam λ₁, ΔI_{λ}_{₂} represents a variation from a baseline data intensity signal in the native frequency optical beam λ₂, and ƒ is a function which is at least partially dependent upon the projector design.

Although the concepts of the present invention are described primarily in the context of image projection, it is contemplated that various concepts of the present invention may also be applicable to any laser application where repeatable fluctuation of the laser wavelength is an issue.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a multi-color laser projection system;

FIG. 2 is an illustration of a scanned laser image in need of color correction;

FIG. 3 is an illustration of a color-corrected scanned laser image;

FIG. 4 is an illustration of a scanned laser image in need of brightness balancing; and

FIG. 5 is an illustration of a brightness-balanced scanned laser image.

### DETAILED DESCRIPTION

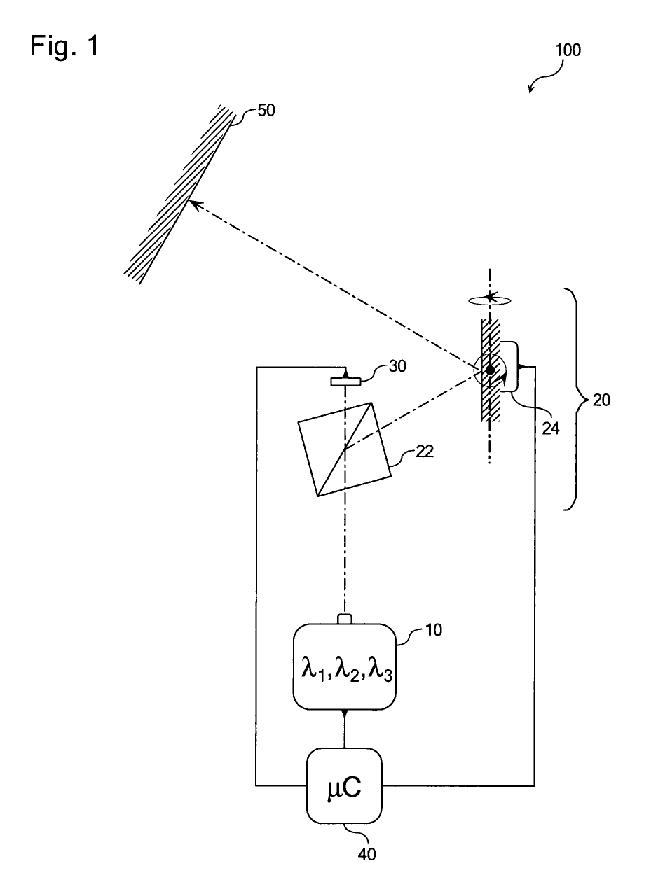

Referring initially to FIG. 1, particular embodiments of the present invention can be described in the context of a multi-color laser projection system 100 comprising a multi-color laser source 10, laser projection optics 20, an optical intensity monitor 30, and a projection controller 40. As is illustrated in FIG. 1, the multi-color laser source can be configured to operate as an RGB scanning projector that generates a frequency-converted optical beam λ₁, e.g., a green laser beam, and one or more native frequency optical beams λ₂, λ₃, e.g., red and blue laser beams.

The laser projection optics 20 may comprise a variety of optical elements including, but not limited to, a partially reflective beam splitter 22 and a scanning mirror 24. These optical elements cooperate to generate a two-dimensional scanned laser image on a projection screen or image plane 50 utilizing the frequency-converted optical beam λ₁ and the native frequency laser beams λ₂, λ₃. In addition, according to one contemplated arrangement for monitoring the intensity of the frequency-converted optical beam λ₁, the partially reflective beam splitter 22 is configured to partially filter the optical beams λ₁, λ₂, λ₃ and directs a portion of the frequency-converted optical beam λ₁, to the optical intensity monitor 30. It is contemplated that a variety of alternative configurations may be utilized to monitor the intensity of the frequency-converted optical beam λ1 without departing from the scope of the present invention.

The optical intensity monitor 30 is configured to generate an electrical or optical signal representing variations in the intensity of the frequency-converted optical beam λ₁. The projection controller 40, which is in communication with the optical intensity monitor 30, receives or samples the portion of the frequency-converted optical beam λ₁ that was directed to the optical intensity monitor 30 and is programmed to compensate for the intensity errors occurring in the frequency-converted optical beam λ₁ such that

ΔI_{λ}_{₂}=ƒ(ΔI_{λ}₁)

ΔI_{λ}_{₃}=g(ΔI_{λ}_{₁})

where Δl_{λ}_{₁} represents a variation from a baseline data intensity signal in the frequency converted optical beam λ₁, ΔI_{λ}_{₂} represents a variation from a baseline data intensity signal in the native frequency optical beam λ₂, ΔI_{λ}_{₁} represents a variation from a baseline data intensity signal in the additional native frequency optical beam λ₃, and ƒ and g are functions that are at least partially dependent upon the projector design. Typically, ΔI_{λ}_{₁} will represent the difference between the intended intensity of the individual pixels of the projected image and the actual intensity, as represented by the monitored intensity signal. Values for ΔI_{λ}_{₂} and ΔI_{λ}_{₃} represent corrections that are intentionally introduced in the signal of the native frequency optical beams λ₂, λ₃.

In an embodiment of this invention, the native frequency optical beams λ₂, λ₃ are delayed in time with respect to the frequency converted beam λ₁. In laser scanning projectors, for instance, the image is produced by scanning multiple spots corresponding to the image colors on the projection screen. With a small angular misalignment between the beams, each color addresses each pixel of the image at a slightly different time. For example, the three beams λ₁ λ₂, and λ₃, may be separated by one or two lines in the image plane 50, and by a one or two pixels in the direction along the lines. By providing a scanning pattern of the scanning mirror 24 that extends a small but sufficient distance beyond the edges of the image plane 50, each of the beams is scanned over the entire image plane 50, but with each color beginning the frame at a slightly different time, then moving through the frame together in the same order. Thus each pixel receives all three beams, but in a specific temporal order. The signals applied to the latter two beams are accordingly delayed by an appropriate amount in time, so that the image is aligned at each pixel. By arranging the angular misalignment of the beams such that the frequency converted beam λ₁ is the first beam entering each frame—that is, the first color in each pixel—the power fluctuations of the frequency converted beam λ₁ can be monitored and corresponding corrections can be applied to the other colors a posteriori.

It should also be noted that the schemes for color correction and brightness balance set forth herein can be somewhat more elaborate than the relatively general equations set forth. For example, it may be preferable to discriminate between low and high spatial frequency content images by applying different types of corrections to the low and high spatial frequency content portions of an image. Contemplated functions may comprise the use of low pass or high pass filter functions and may be applied to the frequency doubled signal ΔI_{λ}_{₁} to arrive at an optimum correction.

For the purposes of describing and defining the present invention, it is noted that projection systems according to the present invention need not be three-color projection systems and may, for example, merely employ the frequency converted optical beam λ₁ and merely one of the native frequency optical beams λ₂, λ₃. As a further alternative, it is contemplated that more than two native frequency optical beams λ₂, λ₃ and more than one frequency converted optical beam λ₁ may be utilized. It is also noted that a “baseline” data intensity signal is that portion of the image data representing intensity content of the image to be projected, for the particular wavelength being projected.

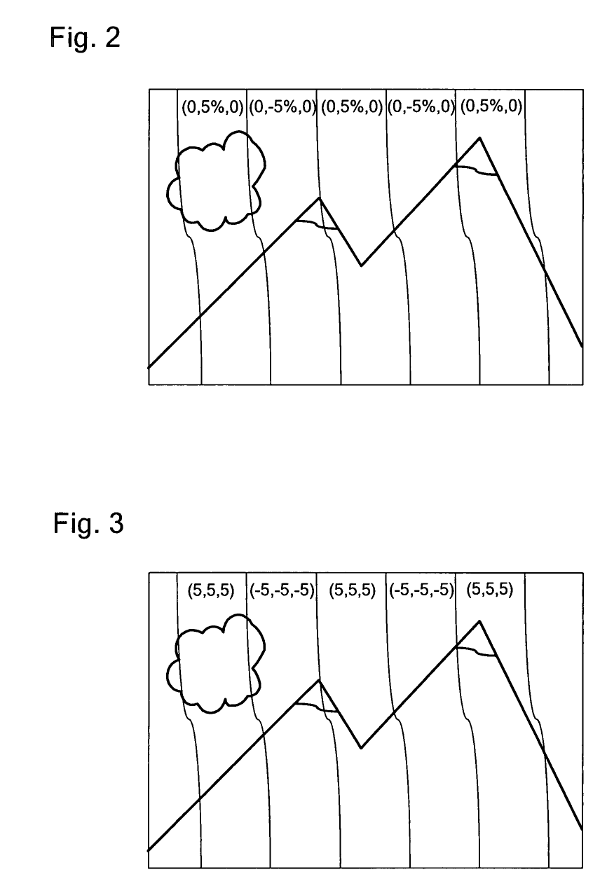

For three-color projection systems, functions ƒ and g can be equivalent functions or may differ slightly, depending on a variety of internal and external conditions affecting the viewing or appearance of the projected image. In any case ƒ and g should be selected to correct for color variations or balance brightness across a projected image. For example, a scanned laser image in need of color correction is represented in FIG. 2, where the respective RGB intensity values are given as coordinates (r,g,b) and represent the respective intensities of the red, green, and blue laser beams, relative to the baseline data intensity signal for each color. In the illustrated image, the green intensity varies by a margin of about ±5% across the image, generating readily recognizable bands that will either appear too green (0,5,0) or too purple (0,−5,0). Although the color variation of FIG. 2 is illustrated in discrete bands, the typical case will actually comprise a gradual color gradient where the green intensity varies from the baseline data intensity by ±5%. The result is a clearly visible image defect where the variation of the color from green to purple is clearly evident because the eye is very sensitive to variations of colors over a relatively large surface area.

Referring now to FIG. 3, a color-corrected image is illustrated where the projection controller 40 is programmed to execute a color correction routine by compensating for the intensity errors occurring in the frequency-converted optical beam λ₁ using color correction functions ƒ and g such that

ΔI_{λ}_{₂}=ƒ(ΔI_{λ}_{₁})

and

ΔI_{λ}_{₃}=g(ΔI_{λ}_{₁})

For example, the functions ƒ and g can be selected such that, the 5% fluctuation of the green power described with reference to FIG. 2 can be followed by corresponding 5% fluctuations in power in the red and blue, creating a constant color across the image. The functions ƒ and g are color correction functions having values that are selected to correct visually apparent color content variations in the scanned laser image. In typical laser scanner projectors, such a correction can easily be achieved by introducing a time delay between the colors and by monitoring the green power as a function of time. The form for functions ƒ and g are often primarily influenced by the operating characteristics of the projector. Typically, these functions can be established or approximated by measuring how much variation of the native frequency optical beams λ₂, λ₃ is needed to maintain a global white image when modifying the frequency doubled power in the frequency-converted optical beam λ₁.

In FIG. 2, which illustrates visually apparent color content variations in a scanned laser image, the defects generated by the frequency converted optical beam λ₁ introduce low spatial frequency artifacts in the projected image. In the case where no correction is applied to the other colors, the impact over the image is a low spatial frequency variation of the color across the image. This low spatial frequency variation creates image defects that are usually extremely visible. As an example, in an image such as a snowy landscape, having some areas that are white and some other ones that are more purple or more cyan can be extremely disturbing. If the intensity of the other colors is adjusted to guarantee a correct color balance, the result of the artifact is a variation of the grey intensity across the image. Because of the fact that human perception is not very sensitive to low spatial frequency intensity variations, these types of defects are much harder to detect. This human perception feature being mostly true for low spatial frequencies, the correction described above should typically only be applied on low spatial frequency images. As such, it is contemplated that a low pass filter may be applied to ΔI_{λ}_{₁} before using the formulas described above

ΔI_{λ}_{₂}=ƒ(LP(ΔI_{λ}_{₁}))

and

ΔI_{λ}_{₃}=g(LP(ΔI_{λ}_{₁}))

where LP represents a low pass filter.

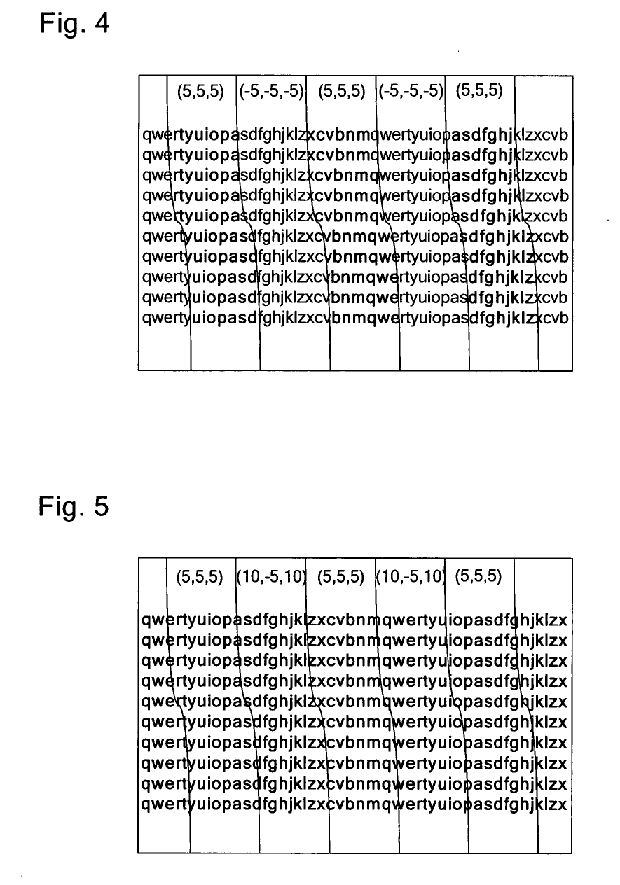

Although the aforementioned color correction routine may be executed in a variety of embodiments, it is contemplated that the projection controller 40 can be programmed to execute the color correction routine when relatively low spatial frequency image data dominate relatively high spatial frequency image data in the scanned laser image, as would be the case with images similar to the landscape represented schematically in FIGS. 2 and 3. In contrast, referring to FIGS. 4 and 5, the projection controller 40 can be programmed to execute a brightness balance routine when relatively high spatial frequency image data dominate, as is the case with text-heavy images. Under the brightness balance routine, the intensity of the native frequency optical beams λ₂, λ₃ is varied in opposition to the intensity of the frequency-converted optical beam λ₁ using brightness balance functions h and i such that

ΔI_{λ}_{₂}=h(ΔI_{λ}_{₁})

and

ΔI_{λ}_{₃}=i(ΔI_{λ}_{₁})

Because the brightness balance routine is mostly applicable for images having high spatial frequencies, the brightness balance correction described above should typically only be applied on high spatial frequency image defects. As such, it is contemplated that a high pass filter may be applied to ΔI_{λ}_{₁} before using the formulas described above:

Δhd λ_{₁}=h(HP(ΔI_{π}_{₁}))

and

ΔI_{λ}_{₃}=i(HP(ΔI_{λ}_{₁}))

where HP represents a high pass filter.

The brightness balance functions h and i have forms that are selected to balance visually apparent brightness variations in the scanned laser image. In this manner, as is illustrated in FIG. 5, the brightness balance routine establishes (r,g,b) coordinates to enhance the visibility of small details in the image by helping to ensure average brightness across the image, as contrasted with the respective (r,g,b) coordinates illustrated in FIG. 4, which are not brightness-balanced. It is contemplated that it may be preferable to execute the brightness balance routine where an image has relatively low color content or where correct color balance is of less importance. As is noted above, the functions h and i are often primarily influenced by the operating characteristics of the projector and can be calibrated by measuring how much the other colors need to be modified when modifying the intensity of the frequency-converted optical beam λ₁ to help ensure that the global intensity remains constant.

In instances where the spatial frequency of the image data embodied in a particular projection varies between relatively high and low values, it may be preferable to program the controller to switch between execution of the color correction routine and the brightness balance routine based on the spatial frequency of image data in the scanned laser image.

Regardless of which routine is employed, because each routine relies upon the monitored intensity of the frequency-converted optical beam λ₁, it will typically be necessary to program the projection controller 40 to provide a time delay Δt between image data resident in the native frequency optical beams λ₂, λ₃ and the frequency-converted optical beam λ₁. The time delay should be tailored to permit the monitored intensity variations in the frequency-converted optical beam λ₁ to be used to vary the intensity of the native frequency optical beams λ₂, λ₃ without disrupting synchronization of the image data resident in the native frequency optical beams λ₂, λ₃ and the frequency-converted optical beam λ₁.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present invention being “programmed” in a particular way, “configured” or “programmed” to embody a particular property, or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present invention or to emphasize alternative or additional features that may or may not be utilized in a particular embodiment of the present invention.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A multi-color laser projection system comprising a multi-color laser source, laser projection optics, an optical intensity monitor, and a projection controller, wherein:
the multi-color laser source is configured to generate a frequency-converted optical beam λ₁ and at least one native frequency optical beam λ₂;
the laser projection optics is configured to generate an image utilizing the frequency-converted optical beam λ₁ and the native frequency optical beam λ₂;
the laser projection optics is configured to direct a portion of the frequency-converted optical beam λ₁ to the optical intensity monitor;
the optical intensity monitor and the projection controller are configured to generate a signal representing errors in the intensity of the frequency-converted optical beam λ₁; and
the projection controller is programmed to apply a compensation signal to the native frequency optical beam λ₂ to compensate for the intensity errors occurring in the frequency-converted optical beam λ₁.

2. A multi-color laser projection system as claimed in claim 1 wherein:
the projection controller is programmed to provide a time delay Δt between image data resident in the native frequency optical beam λ₂ and the frequency-converted optical beam λ₁; and
the time delay is sufficient to permit the monitored intensity variations in the frequency-converted optical beam λ₁ to be used to vary the intensity of the native frequency optical beam λ₂ without disrupting approximate synchronization of the image data resident in the native frequency optical beam λ₂ and the frequency-converted optical beam λ₁.

3. A multi-color laser projection system as claimed in claim 1 wherein:
the laser projection optics is configured to generate a scanned laser image utilizing the frequency-converted optical beam λ₁ and at least two native frequency optical beams λ₂, λ₃;
the projection controller is programmed to provide a time delay Δt between image data resident in the native frequency optical beams λ₂, λ₃ and the frequency-converted optical beam λ₁; and
the time delay is sufficient to permit the monitored intensity variations in the frequency-converted optical beam λ₁ to be used to vary the intensity of the native frequency optical beams λ₂, λ₃ without disrupting approximate synchronization of the image data resident in the native frequency optical beams λ₂, λ₃ and the frequency-converted optical beam λ₁ .

4. A multi-color laser projection system as claimed in claim 1 wherein:
the laser projection optics comprises a spatial light modulator and is configured to generate a laser image from a sequence of image frames utilizing the frequency-converted optical beam λ₁ and at least two native frequency optical beams λ₂, λ₃;
the projection controller is programmed to provide a time delay Δt between image data resident in the native frequency optical beams λ₂, λ₃ and the frequency-converted optical beam λ₁; and
the time delay is sufficient to permit the monitored intensity variations in the frequency-converted optical beam λ₁ to be used to compensate for the intensity errors occurring in the frequency-converted optical beam λ₁ on a frame-by-frame basis without disrupting approximate synchronization of the image data resident in the native frequency optical beams λ₂, λ₃ and the frequency-converted optical beam λ₁.

5. A multi-color laser projection system as claimed in claim 1 wherein:
the projection controller is programmed to compensate for the intensity errors occurring in the frequency-converted optical beam λ₁ such that
ΔI_{λ}_{₂}=ƒ(ΔI_{λ}_{₁})
where ΔI_{λ}_{₁} represents a variation from a baseline data intensity signal in the frequency converted optical beam λ₁, ΔI_{λ}_{₁} represents a variation from a baseline data intensity signal in the native frequency optical beam λ₂, and ƒ is a function which is at least partially dependent upon projector design.

6. A multi-color laser projection system as claimed in claim 1 wherein
the projection controller is programmed to identify low spatial frequency intensity variations in the projected image and to compensate for the intensity errors occurring in the frequency-converted optical beam λ₁ such that
ΔI_{λ}_{₂}=ƒ(LP(ΔI_{λ}_{₁}))
where LP represents a low pass filter, ΔI_{λ}_{₁} represents a variation from a baseline data intensity signal in the frequency converted optical beam λ₁, ΔI_{λ}_{₂} represents a variation from a baseline data intensity signal in the native frequency optical beam λ₂, and ƒ is a function which is at least partially dependent upon projector design.

7. A multi-color laser projection system as claimed in claim 1 wherein
the projection controller is programmed to identify high spatial frequency intensity variations in the projected image and to compensate for the intensity errors occurring in the frequency-converted optical beam λ₁ such that
ΔI_{λ}_{₂}=h(HP(ΔI_{λ}_{₁}))
where HP represents a high pass filter, ΔI_{λ}_{₁} represents a variation from a baseline data intensity signal in the frequency converted optical beam λ₁, ΔI_{λ}_{₂} represents a variation from a baseline data intensity signal in the native frequency optical beam λ₂, and h is a function which is at least partially dependent upon projector design.

8. A multi-color laser projection system as claimed in claim 1 wherein:
the multi-color laser source is configured to generate an additional native frequency optical beam λ₃;
the laser projection optics is configured to generate the scanned laser image by further utilizing the additional native frequency laser beam λ₃; and
the projection controller is programmed to compensate for the intensity errors occurring in the frequency-converted optical beam λ₁ such that
ΔI_{λ}_{₃}=g(ΔI_{λ}_{₁})
where ΔI_{λ}_{₂} represents a variation from a baseline data intensity signal in the additional native frequency optical beam λ₁ and g is a function which is at least partially dependent upon projector design.

9. A multi-color laser projection system as claimed in claim 1 wherein the projection controller is programmed to switch between execution of a color correction routine and a brightness balance routine based on the spatial frequency of image data in the scanned laser image.

10. A multi-color laser projection system as claimed in claim 1 wherein the projection controller is programmed to execute a color correction routine by compensating for the intensity errors occurring in the frequency-converted optical beam λ₁ using a color correction function ƒ such that
ΔI_{λ}_{₂}=ƒ(ΔI_{λ}_{₁})

11. A multi-color laser projection system as claimed in claim 10 wherein the projection controller is programmed to execute the color correction routine when relatively low spatial frequency image data dominate relatively high spatial frequency image data in the scanned laser image.

12. A multi-color laser projection system as claimed in claim 10 wherein ƒ is a function that is selected to correct visually apparent color content variations in the scanned laser image.

13. A multi-color laser projection system as claimed in claim 1 wherein the projection controller is programmed to execute a brightness balance routine by compensating for the intensity errors occurring in the frequency-converted optical beam λ₁ using a brightness balance function h such that
ΔI_{λ}_{₂}=h(ΔI_{λ}_{₁})

14. A multi-color laser projection system as claimed in claim 13 wherein the projection controller is programmed to execute the brightness balance routine when relatively high spatial frequency image data dominate relatively low spatial frequency image data in the scanned laser image.

15. A multi-color laser projection system as claimed in claim 13 wherein h is a function that is selected to balance visually apparent brightness variations in the scanned laser image.

16. A multi-color laser projection system comprising a multi-color laser source, laser projection optics, an optical intensity monitor, and a projection controller, wherein:
the multi-color laser source is configured to generate a frequency-converted optical beam Xi and at least two native frequency optical beams λ₂, λ₃;
the laser projection optics is configured to generate an image utilizing the frequency-converted optical beam λ₁ and the native frequency optical beams λ₂, λ₃;
the laser projection optics is configured to generate a scanned laser image utilizing the frequency-converted optical beam λ₁ and at least two native frequency optical beams λ₂, λ₃;
the laser projection optics is configured to direct a portion of the frequency-converted optical beam λ₁ to the optical intensity monitor;
the optical intensity monitor and the projection controller are configured to generate a signal representing errors in the intensity of the frequency-converted optical beam λ₁;
the projection controller is programmed to switch between execution of a color correction routine and a brightness balance routine based on the spatial frequency of image data in the scanned laser image;
the projection controller is programmed to execute selectively the color correction routine and the brightness balance routine by applying a compensation signal to the native frequency optical beams λ₂, λ₃ to compensate for the intensity errors occurring in the frequency-converted optical beam λ₁;
the projection controller is programmed to provide a time delay Δt between image data resident in the native frequency optical beams λ₂, λ₃ and the frequency-converted optical beam the time delay is sufficient to permit the monitored intensity variations in the frequency-converted optical beam λ₁ to be used to vary the intensity of the native frequency optical beams λ₂, λ₃ without disrupting approximate synchronization of the image data resident in the native frequency optical beams λ₂, λ₃ and the frequency-converted optical beam λ₁.
